(19) United States
(12) Patent Application Publication
(10) Pub. No.: US 2018/0041722 A1
(43) Pub. Date: Feb. 8, 2018

(54) CIRCUITS AND TECHNIQUES FOR NOISE CONTROL IN DIGITAL IMAGING

(71) Applicant: Analog Devices, Inc., Norwood, MA (US)

(72) Inventors: Erik Barnes, Cambridge, MA (US); Ronald A. Kapusta, Carlisle, MA (US)

(21) Appl. No.: 15/545,677

(22) PCT Filed: Jan. 27, 2016
(86) PCT No.: PCT/US2016/015138

§ 371 Date: Jul. 22, 2017

Related U.S. Application Data
(60) Provisional application No. 62/108,972, filed on Jan. 28, 2015.

(51) Int. Cl. H04N 5/357; H04N 5/378

(52) U.S. Cl. CPC H04N 5/3577; H04N 5/378

(57) ABSTRACT

A regulated supply voltage can be established using switching cycles defined at least in part according to a switching clock period. Imaging information can be acquired from an imaging sensor and a discrete-time representation of the imaging information can be received. Noise, such as corresponding to the switching cycles, can be reduced or suppressed. In an example, a discrete-valued noise template can be stored in a memory, wherein a count of values in the noise template is less than a count of an entirety of a physical row of pixels from the imaging sensor. The discrete-valued noise template can be aligned with a portion of the discrete-time representation of the imaging information. The noise in the discrete-time representation can be at least partially canceled using the aligned discrete-valued noise template. The template can be constructed such as by aggregating imaging information obtained from an optically-black portion of the imaging sensor.

### CLAIM OF PRIORITY

This patent application claims the benefit of priority of Barnes, U.S. Provisional Patent Application Ser. No. 62/108,972, titled “CIRCUITS AND TECHNIQUES FOR NOISE CONTROL IN DIGITAL IMAGING,” filed on Jan. 28, 2015, which is hereby incorporated by reference herein in its entirety.

### TECHNICAL FIELD

This document pertains generally, but not by way of limitation, to circuits and techniques for noise control in digital imaging, wherein the noise is caused at least in part by operation of a power supply.

### BACKGROUND

Digital imaging systems can be used for a variety of applications including consumer, healthcare, and industrial applications. Such imaging systems can include stand-alone devices such as cameras or sensors, or such systems can be included as a portion of a multi-function device, such as a mobile telephone, tablet, laptop, or other device. In some applications, digital imaging systems can include use of one or more switched-mode power supplies. A switched-mode power supply can provide enhanced efficiency or a smaller footprint or volume as compared to a linear power supply having a similar output rating. Moreover, a switched-mode power supply can be useful for generating an output voltage greater in magnitude or lesser in magnitude than an input voltage. For example, in digital imaging applications using a charge-coupled device (CCD) imaging sensor, the switched-mode power supply can generate one or more boosted supply voltages, such as having a magnitude greater than 10 volts, such as for use in generating one or more readout clock signals (e.g., one or more vertical clock signals).

### Overview

Generally, digital imaging systems can include an imaging sensor, and an image acquisition circuit, such as including analog signal conditioning circuitry (e.g., an “analog front end” (AFE). Operating power for a digital imaging system can be provided, such as using one or more switched-mode power supplies. The present inventors have recognized, among other things, that operation of a switched-mode power supply can produce switching transients. Such switching transients can be coupled to other portions of an imaging system, such as introducing noise during one or more of actual image capture or acquisition of previously-captured discrete-time imaging information (e.g., readout and sampling). Such noise can be objectionable to users, such as presenting unwanted visual artifacts in acquired images, such as in low light conditions, or reducing a signal-to-noise ratio in acquired imaging information in other applications such as spectroscopy or time-of-flight imaging.

For example, in the presence of power-supply-induced noise, acquired images can include lines or patterns that are perceptible to users. In sensing or other applications, such imaging information can include artifacts that can inhibit or prevent processing of such imaging information, or such noise can decrease a sensitivity or accuracy of sensing equipment. Co-integration of at least a portion of a switched-mode power supply circuit in a monolithic integrated circuit along with an AFE or other circuitry can worsen such noise coupling.

Accordingly, the present inventors have recognized that a variety of techniques can be used to reduce or inhibit power-supply-induced noise. Such techniques can facilitate integration of switched-mode power supply circuitry with the AFE or other functional blocks of an imaging system. Along with use of one or more circuits or techniques shown and described herein, such co-integration can one or more of reduce cost, reduce physical footprint, reduce energy consumption, and can even suppress coupling of other sources of noise to the imaging system.

In an example, an electronic system, can include a switched-mode power supply circuit configured to establish a regulated supply voltage, the switched-mode power supply circuit configured to operate using switching cycles defined at least in part according to a switching clock period. The electronic system can include an imaging acquisition circuit comprising an input configured to acquire imaging information from the imaging sensor and an output configured to provide a discrete-time representation of the imaging information acquired from the imaging sensor. The electronic system can include a discrete-time noise suppression circuit coupled to the output of the imaging acquisition circuit, the discrete-time noise suppression circuit configured to receive the discrete-time representation of the imaging information and configured to reduce or suppress in the discrete-time representation noise corresponding to operation of the switched-mode power supply circuit during acquisition of the imaging information. The discrete-time noise suppression circuit can include a discrete-valued noise template stored in a memory, wherein a count of values in the noise template is less than a count of an entirety of a physical row of pixels from the imaging sensor and a noise subtraction circuit configured to align the discrete-valued noise template with a portion of the discrete-time representation of the imaging information and configured to use the aligned template to at least partially cancel the noise in the discrete-time representation corresponding to operation of the switched-mode power supply circuit.

In an example, a technique, such as a method, can include establishing a regulated supply voltage using switching cycles defined at least in part according to a switching clock period, acquiring imaging information from an imaging sensor, providing a discrete-time representation of the imaging information acquired from the imaging sensor, and receiving the discrete-time representation of the imaging information and reducing or suppressing in the discrete-time representation noise during the acquisition of the imaging information. Receiving the discrete-time representation of the imaging information can include generating a discrete-valued noise template stored in a memory, wherein a count of values in the noise template is less than a count of an entirety of a physical row of pixels from the imaging sensor, and aligning the discrete-valued noise template with a portion of the discrete-time representation of the imaging information and at least partially canceling the noise in the discrete-time representation using the aligned discrete-valued noise template.

In an example, a regulated supply voltage can be established using switching cycles defined at least in part according to a switching clock period. Imaging information can be acquired from an imaging sensor and a discrete-time representation of the imaging information can be received. Noise, such as corresponding to the switching cycles, can be reduced or suppressed. In an example, a discrete-valued noise template can be stored in a memory, wherein a count of values in the noise template is less than a count of an entirety of a physical row of pixels from the imaging sensor. The discrete-valued noise template can be aligned with a portion of the discrete-time representation of the imaging information. The noise in the discrete-time representation can be at least partially canceled using the aligned discrete-valued noise template. The template can be constructed such as by aggregating imaging information obtained from an optically-black portion of the imaging sensor.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 illustrates generally an example comprising an electronic system, such as can include an imaging acquisition circuit, a switching power supply, and a noise suppression circuit.

FIG. 2 illustrates generally an example comprising an electronic system, such as can include an imaging acquisition circuit comprising one or more of an analog front end (AFE) and a timing generator (TG).

FIG. 3A illustrates generally an example of an electronic system comprising a synchronous clock distribution scheme, such as can be used to facilitate synchronization between a master clock input (CLI) and a power management unit (PMU) clock.

FIG. 3B illustrates generally an example of an electronic system comprising an asynchronous clock distribution scheme, such as can be used to sample and refer a power management unit (PMU) clock to a clock domain used by one or more of an analog front end (AFE) or noise suppression circuit (NSC).

FIG. 4A shows an illustrative example of a technique, such as a method, that can include obtaining one or more segments from an optically-black region of an imaging sensor, such as for use in establishing a noise template as shown in FIG. 4B.

FIG. 4B shows an illustrative example of a technique, such as a method, that can include aggregating “N” segments of imaging information having “M” locations in each segment into a noise template.

FIG. 4C shows an illustrative example of a technique, such as a method, that can include using a noise template to suppress or remove noise from acquired imaging information.

FIG. 5 illustrates generally a technique, such as a method, that can include reducing or suppressing noise in an acquired discrete-time representation of imaging information, such as at least in part using a noise template.

FIG. 6 illustrates generally a timing diagram showing a relationship between various discrete-time signals, such as can be used in relation to a Time-of-Flight (TOF) imaging technique.

FIG. 7 illustrates generally a technique, such as a method, that can include reducing or suppressing noise during image capture in relation to Time-of-Flight (TOF) imaging.

FIG. 8 illustrates generally a block diagram of a machine 800 upon which any one or more of the techniques (e.g., methodologies) discussed elsewhere herein can be performed.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

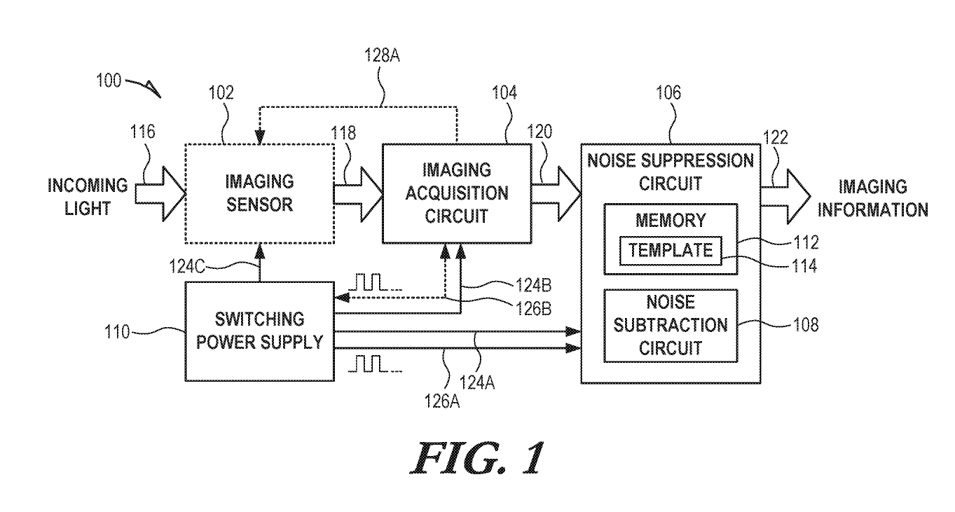

FIG. 1 illustrates generally an example comprising an electronic system 100, such as can include an imaging acquisition circuit 104, a switching (e.g., switched-mode) power supply 110 (or a power management unit (PMU) configured to control one or more switching supplies), and a noise suppression circuit 106. The switching power supply circuit can include one or outputs 124A, 124B, or 124C, such as to provide operating energy or reference voltages for other portions of the system 100. The imaging acquisition circuit 104 can be electrically coupled to an imaging sensor 102, such as a charge-coupled device (CCD) imaging sensor or a Complementary Metal-Oxide-Semiconductor (CMOS) imaging sensor, as illustrative examples. In examples involving CCD imaging sensors, some of the voltages provided by the switching power supply circuit 110 can be significantly larger in magnitude than an input voltage to the electronic system 100. Transients involving such voltages are therefore likely to more readily couple to surrounding circuits, particularly if portions of the electronic system 100 are co-integrated as a portion of a commonly-shared integrated circuit or integrated module.

Incoming light 116 can cause charge accumulation in various regions of the imaging sensor 102, and the imaging acquisition circuit 104 can be used to convert the stored charge transferred as an analog signal 118 to a discrete-time (e.g., digital) representation 120 of imaging information received by the imaging sensor 102. A noise suppression circuit 106 can be used, such as to remove noise generated during one or more of image capture (e.g., physical or electrical shuttering to trigger capture of an image by the imaging sensor 102), or during acquisition of imaging information (e.g., readout and sampling) from the imaging sensor 102. The noise suppression circuit can provide an output 122 including a representation of the imaging information having noise suppressed or removed.

In an example, the noise suppression circuit 106 can include or can be coupled to a memory 112 having a stored noise template 114. The stored noise template can include information representative of switching transients induced in one or more of the analog signal 118 or discrete-time representation 120 of the imaging information. For example, as shown and described in other examples herein, the noise template can include a discrete-time representation of aggregated segments or records, such as a column-averaged noise template comprising a record length (e.g., a count of values) corresponding to a duration comprising an integral number of switching clock periods (e.g., a single clock period, or multiple clock periods). A noise subtraction circuit 108 can be used, such as to remove a “baseline” defined by the noise template 114 from the discrete-time representation of the imaging information 120, to provide the output 122, such as shown and described in relation to other examples herein. For example, the noise subtraction circuit 108 can be used to align the noise template 114 with a portion of the discrete-time representation 120 of the imaging information, and to at least partially cancel the noise in the discrete-time representation 120.

The switching power supply 110 can operate according to switching cycles established at least in part according to a switching clock period. In one approach, the switching clock period can be established using a clock generator included as a portion of the switching power supply 110 or coupled to the switching power supply 110. The imaging acquisition circuit can perform readout or other control operations related to imaging such as using another clock signal (e.g., a master clock or pixel clock), such as established independently of the power supply 110 clock signal. For example, one or more vertical or horizontal clock signals can be provided by a sensor clock output 128A from the imaging acquisition circuit 104 (such as one or more outputs from a timing generator included as a portion of the imaging acquisition circuit 104 or coupled to the imaging acquisition circuit 104).

The present inventors have recognized, among other things, that the pixel clock and power supply clock signals can be synchronized, or the power supply clock signal can be sampled, such as to deterministically spatially map power supply clock cycles to portions of the acquired imaging information. In this manner, the noise template can be establish, such as using aggregated information from an optically-black region of the imaging sensor 102. Information indicative of the power supply clock can be provided to the noise suppression circuit 106, such as using a clock output 126A from the switching power supply 110 or using one or more other signals. For example, synchronization can be accomplished such as by generating the pixel clock signal, and establishing a power supply clock signal as a sub-multiple of the pixel clock signal. The power supply clock signal can be generated using a timing generator included as a portion of the imaging acquisition circuit 104, and provided through an output 126B to the switching power supply 110. In another example, the switching power supply 110 can provide the clock signal to the imaging acquisition circuit.

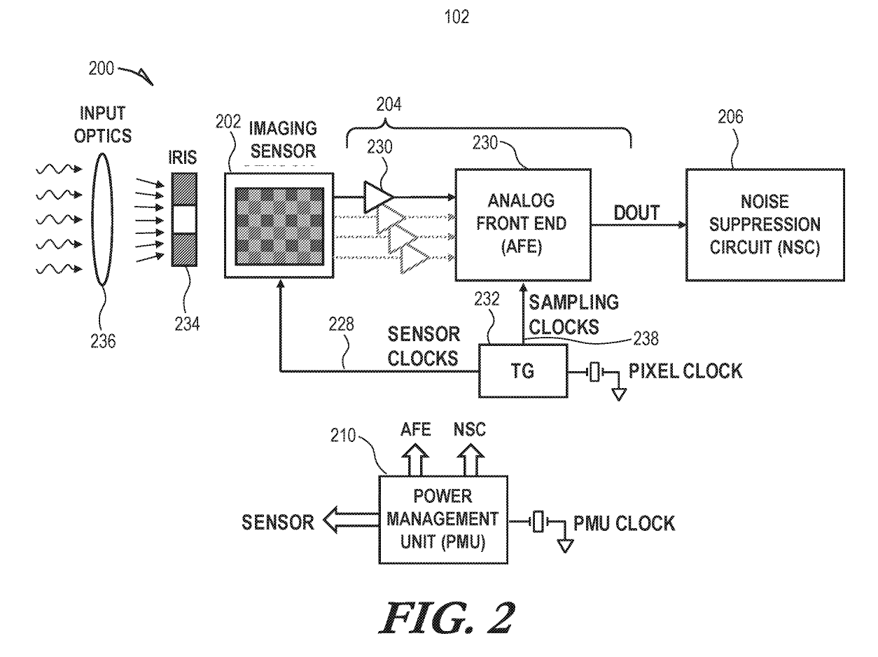

FIG. 2 illustrates generally an example comprising an electronic system 200, such as can include an imaging acquisition circuit 204 comprising one or more of an analog front end (AFE) 230 and a timing generator (TG) 232, along with other circuitry such as one or more buffers or amplifiers 230. Incident light (e.g., visible or infrared light) is relayed through input optics 236 (e.g., one or more lenses). An optical stop can be provided, such as using an iris 234. The iris 234 or other optically-opaque structures can define various regions on an imaging sensor 202, such as including an “active” imaging area, and one or more “optically black” regions. An optically-black region need not be literally “black,” but is generally not irradiated by incident light and generally includes a detected intensity level below a specified threshold.

Transfer of imaging information from the imaging sensor 202 to the AFE (230) can be controlled in part using one or more sensor clocks 238. For example, such clocks can be used to control one or more shift register structures (e.g., in an example including a CCD imaging sensor), or to address specific pixels (e.g., in an example including a CMOS imaging sensor). The sensor clocks 238 can be generated using a timing generator 232. The timing generator 232 can include circuitry such as oscillators and logic to synthesize the sensor clocks 228, and other signals, such as one or more sampling clocks 238 for use by the AFE. The timing signals generated by the timing generator 232 can be derived from a master clock, such as a pixel clock.

The imaging sensor, analog front end 230, and other portions of the system 200 can be powered using one or more outputs provided by a power management unit (PMU) 210 controlling or comprising one or more switched-mode power supplies. In one approach, the PMU can control one or more switched-mode power supplies according to switching cycles derived from a switching clock (e.g., a “PMU clock”), such as a switching clock established asynchronously with respect to the pixel clock.

As mentioned above, the present inventors have recognized, among other things, that operation of a switched-mode power supply can produce switching transients. Such switching transients can be coupled to other portions of an imaging system, such as introducing noise during one or more of actual image capture or acquisition of previously-captured discrete-time imaging information (e.g., readout and sampling). Such noise can be objectionable to users, such as presenting unwanted visual artifacts in acquired images, such as in low light conditions, or reducing a signal-to-noise ratio in acquired imaging information in other applications such as spectroscopy or time-of-flight imaging.

Accordingly, the present inventors have recognized that a variety of techniques can be used to reduce or inhibit power-supply-induced noise. Such techniques can facilitate integration of switched-mode power supply circuitry with the AFE 230 or other functional blocks of the electronic system 200. Along with use of one or more circuits or techniques shown and described herein, such co-integration can one or more of reduce cost, reduce physical footprint, reduce energy consumption, and can even suppress coupling of other sources of noise to the imaging system.

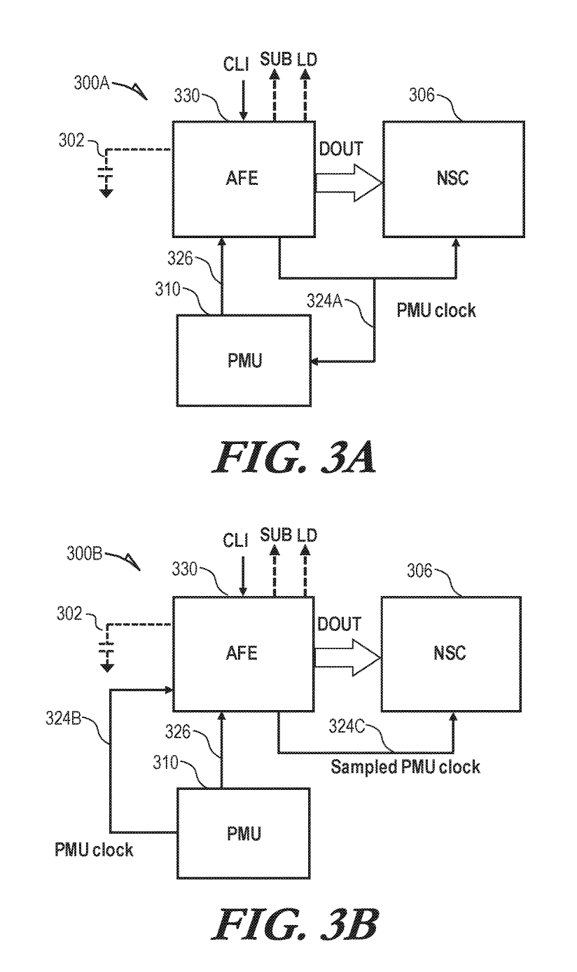

In FIG. 2, a noise suppression circuit 206 can be included, such as configured to receive a discrete-time (e.g., digital) representation of imaging information from the analog front end (AFE). The noise suppression circuit 206 can use information indicative of the PMU clock such as to establish a noise template. The noise template can be used to reduce or suppress power-supply-induced noise from imaging information, as shown and described in relation to other examples herein. For example, FIG. 3A and FIG. 3B show illustrative examples of use of a PMU clock such as to define segment boundaries of sampled noise information for aggregation as a noise template. The PMU clock can be a sub-multiple of the pixel clock.

FIG. 3A illustrates generally an example of an electronic system 300A comprising a synchronous clock distribution scheme, such as can be used to facilitate synchronization between a master clock input (CLI), such as corresponding to a pixel clock, and a power management unit (PMU) clock 324A. An analog front end (AFE) 330 can be coupled to an output of an imaging sensor 302 (which is shown as a capacitor). The AFE 330 can be powered by an output 326 of the PMU 310. The AFE 330 can include or can be coupled to a timing generator, such as to synthesize the PMU clock 324A rate as a sub-multiple of master clock rate (e.g., the PMU clock 324A can include a period that is a specified multiple of a period of the pixel clock or some other clock signal).

The synthesized PMU clock 324A can also be fed to the noise suppression circuit 306, such as for use in one or more of defining segment boundaries, aggregating acquired segments for generation of a noise template, or alignment of a noise template with discrete-time imaging information provided by the AFE 330.

FIG. 3B illustrates generally an example of an electronic system 300B comprising an asynchronous clock distribution scheme, such as can be used to sample and refer a power management unit (PMU) clock 324B to a clock domain used by one or more of an analog front end (AFE) 330 or noise suppression circuit (NSC) 306. For example, the clock domain used by the AFE 330 and NSC 306 can be referenced to a master clock input (CLI), such as defining a pixel clock. As in the illustrative example of FIG. 3A, the AFE 330 can acquire imaging information from an imaging sensor 302. The AFE can receive the PMU clock signal 324B from the PMU 310 (such as defining a clock period for switching cycles of one or more switched-mode supplies controlled by or included as a portion of the PMU). The AFE 330 can sample the PMU clock 324B to generate a re-timed or sampled PMU clock 324C, such as for use by the noise suppression circuit (NSC) 306 in removing or suppressing noise in discrete-time imaging information received from the AFE 330. As an illustrative example, certain off-the-shelf AFE 330 circuits may include multiple analog inputs. The PMU clock 324B can be provided to an otherwise unused analog input, and can be sampled by the AFE 330. The AFE 330 can use an otherwise unused digital output to provide the sampled PMU clock 324C.

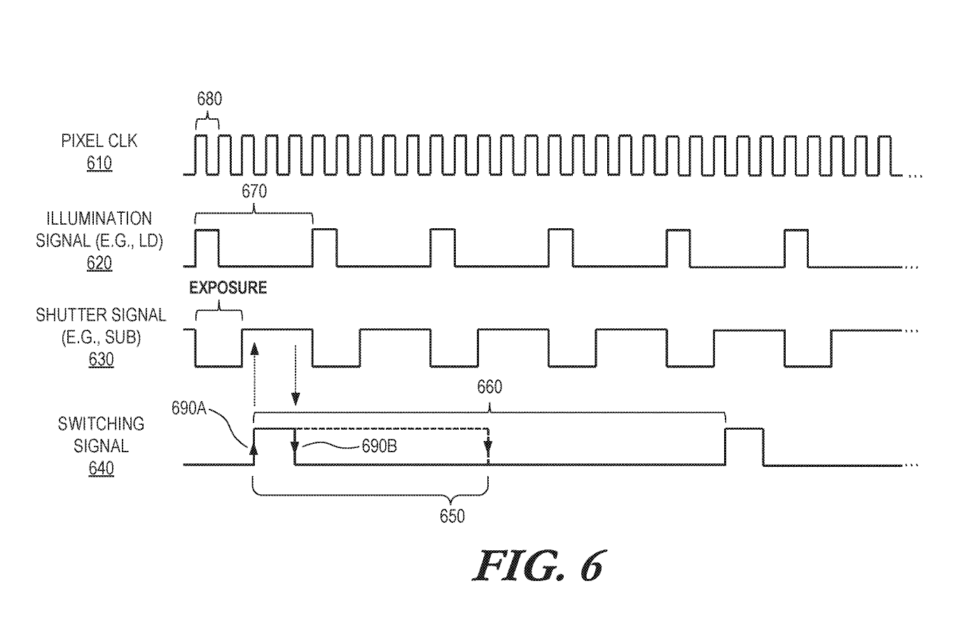

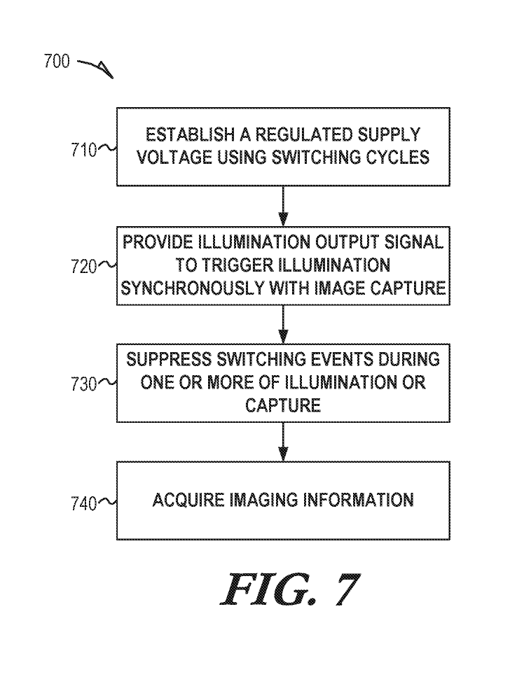

In certain applications, such as Time-of-Flight imaging, in the context of the examples of FIG. 3A and FIG. 3B, the AFE 330 (or timing generator) can also provide one or more other signals such as an exposure or shutter signal (e.g., “SUB”), or an illumination signal (e.g., “LD”). As shown and described in relation to FIG. 6 and FIG. 7, the PMU 310 can be controlled such as to suppress switching events or switching cycles during one or more of illumination or exposure, to avoid unwanted noise coupling from the PMU 310 to the imaging sensor 302 during image capture. Such control can include suppressing generation of the PMU clock (324A in FIG. 3A or 324B in FIG. 3B), or masking of the PMU clock.

Various elements or circuits shown in the examples of FIG. 1, FIG. 2, FIG. 3A or FIG. 3A can be co-integrated in a commonly-shared integrated circuit or module. For example, an imaging sensor can be co-integrated with a portion or an entirety of an image acquisition circuit (such as including the analog front end) or other circuitry such as an application-specific noise suppression circuit or an embedded or general-purpose processor circuit implementing a noise suppression circuit or technique. In another example, an imaging sensor can be a separate circuit or assembly, such as electrically coupled to an image acquisition circuit in a module or assembly.

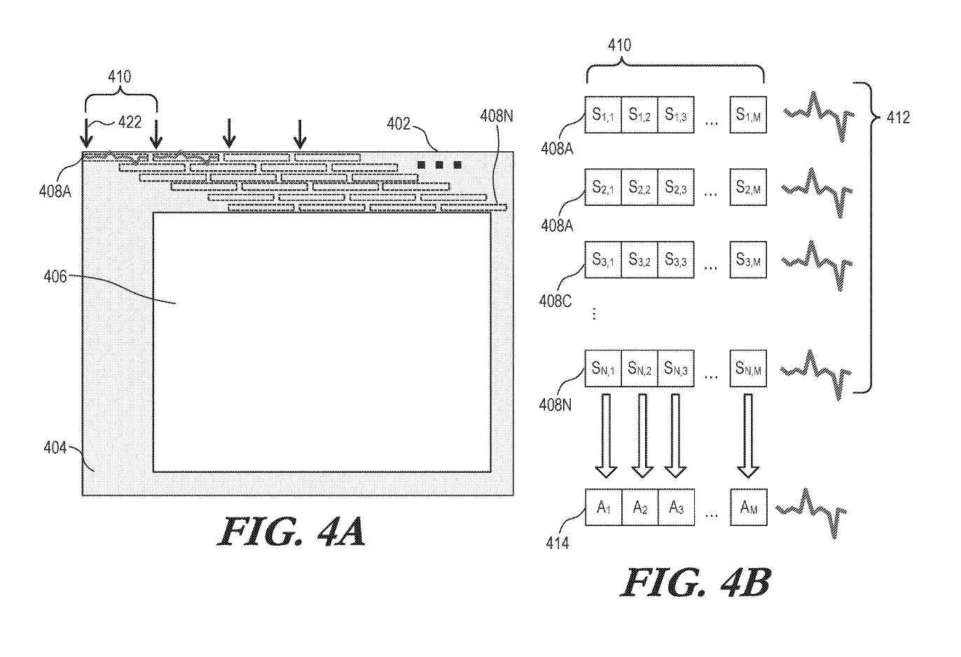

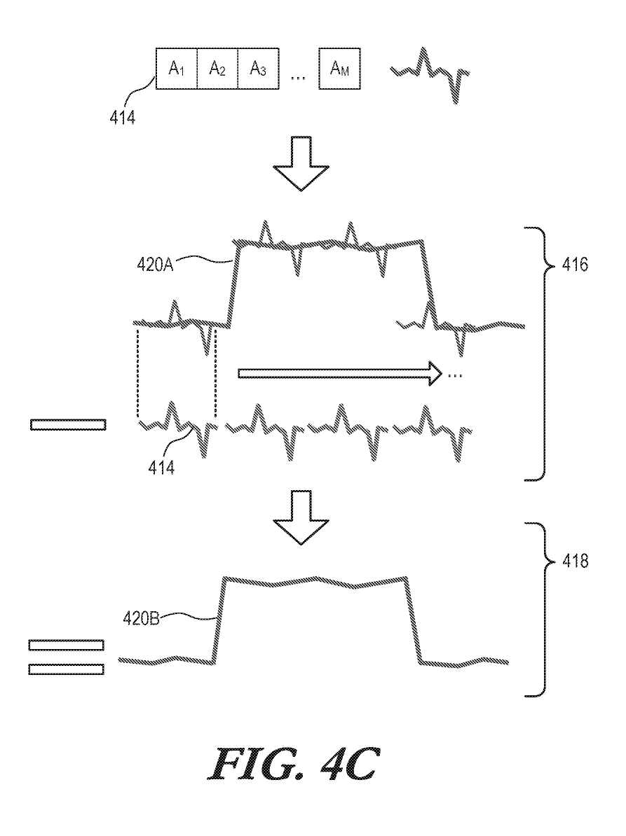

FIG. 4A shows an illustrative example of a technique, such as a method, that can include obtaining one or more segments from an optically-black region 404 of an imaging sensor 402, such as for use in establishing a noise template 414 as shown in FIG. 4B. Referring back to FIG. 4A, a row (e.g., line) of pixels in an imaging sensor can be subdivided (e.g., partitioned) into segments, such as a segment 408A. In this manner, a count of values in the noise template 414 is generally less than a count of an entirety of a physical row of pixels from the imaging sensor. A spatial length 410 of the segment 408A can correspond to a duration of a switching clock cycle (e.g., a “PMU clock” cycle) as a multiple of a pixel clock duration. In this manner, if the switching clock cycle is established as a sub-multiple of the pixel clock, and the segment 408A length 410 will include multiple pixel locations.

If the switching clock cycle is synchronized or re-timed to align with the pixel clock, each segment 408A through 408N can include a specified count of values, such as corresponding to the relationship between the pixel clock rate and the switching clock cycle. As an illustrative example, if a pixel clock rate is established at 40 Megahertz (MHz) and a switching clock rate is established at 2 MHz, then each column segment can include a length 410 corresponding to 20 pixels.

As shown illustratively in FIG. 4A, a series of segments 408A through 408N can be obtained from an optically-black region 404 of the imaging sensor 402. Use of an optically-black region 404 rather than an active area 406 allows a “baseline” noise template to be established. In an example, the active area 406 can be used, such as if a physical shutter is used to render the active area 406 optically-black. If the segment boundaries (such as a boundary 422) are established to coincide with a specified location in one or more switching cycles, then switching transients will appear in the same relative location within each segment 408A through 408N. For example, each boundary 422 can be triggered by a rising or falling edge of a switching clock signal, as illustrative examples. In another example, a boundary 422 can be triggered to define segments each capturing an integral number of switching cycles rather than a single switching cycle. The technique of FIG. 4A can be performed in whole or in part by a noise template generation circuit, such as included as a portion of a noise suppression circuit as shown and described in relation to the examples of FIG. 1 or FIG. 2.

FIG. 4B shows an illustrative example of a technique, such as a method, that can include aggregating “N” segments of imaging information having “M” locations in each segment into a noise template. As mentioned in relation to FIG. 4A, each acquired segment 408A through 408N can include a length 410 (e.g., a count of values, “M”) corresponding to multiple pixel locations. A group 412 of acquired segments 408A through 408N can be aggregated, such as using a column-wise aggregation technique. For example, each of the segments 408A through 408N can include sampled intensity values S_{x,y} where “x” corresponds to the row location and “y” corresponds to the column location, to define an array of “N” by “M” intensity values. For example, values S_{x,1} (x=1, 2, 3, . . . , N) are aggregated to provide a first noise template 414 value A1, and all values S_{x,2} (x=1, 2, 3, . . . , N) are aggregated to provide a second noise template 414 value A2, and so on through all M columns. Aggregation can include determining a central tendency of the column values, such as an average (e.g., an arithmetic or geometric mean). Other techniques can be used, such as taking a maximum or minimum value, or a statistical “mode” of acquired values in a particular column, to provide a corresponding value in the noise template 414. Acquired segments can be subdivided or grouped in various manners, such as by pixel color, as long as the columns are temporally aligned to the same relative position in the switching cycle defined by the switching clock. As shown below, the determined noise template 414 can be used by a noise suppression circuit to reduce or suppress noise in imaging information.

FIG. 4C shows an illustrative example of a technique, such as a method, that can include using a noise template to suppress or remove noise from acquired imaging information. A noise template 414 can be established, such as using the techniques shown and described in relation to FIG. 4A and FIG. 4B or other examples herein. At 416, the noise template 414 can be aligned with imaging information 420A, where the imaging information 420A is acquired from an active area of an imaging sensor.

The alignment is shown graphically at 416, but the imaging information 420A and noise template 414 are generally discrete-time representations (e.g., digital values) and such alignment can include selecting a location or value along the imaging information 420A record corresponding to a known location within a switching cycle, for example. One or more instances of the noise template can then be subtracted on a sample-by-sample basis from the imaging information 420A. In the illustration of FIG. 4C, the imaging information 420A includes a record length spanning multiple durations of the noise template 414 and thus the noise template 414 can be repeatedly subtracted along the length of the imaging information 420A record. At 418, processed imaging information 420B can be provided, such as having noise corresponding to the template 414 reduced or suppressed. As described in other examples, the noise template 414 can be representative of noise corresponding to the operation of one or more switched-mode power supplies, and the imaging information 420B can include a series of pixel values spanning a duration of multiple switching cycles.

The alignment shown graphically at 416 can be accomplished using a trigger signal or other timing reference, such as derived from a PMU clock signal or a sampled representation of the PMU clock signal (such as a clock signal reconstructed from the PMU clock signal referred to a different clock domain within an electronic system). In another approach, records stored in a memory corresponding to the imaging information 420A and the template 414 can be indexed relative to a representation of the PMU clock signal (e.g., a first location or record in the imaging information 420A and a first record of the noise template 414 can correspond to the same or about the same location in a switching cycle or the same relative location with respect to a switching event). In another approach, a correlation technique can be used, such as by stepping the noise template 414 across multiple possible alignment positions and selecting an alignment providing a specified correlation result or peak. The technique of establishing a noise template and using the noise template to cancel noise in the imaging information can be described as a fixed-pattern noise (FPN) removal technique. However, by contrast with generally-available FPN approaches, the various techniques described herein do not rely or require computationally-intensive post processing because generation, alignment, and application of the noise template can be achieved using a PMU clock selected as a sub-multiple of a pixel clock, where the PMU clock defines switching cycles deterministically spanning spatial locations of groups of pixels within the imaging sensor.

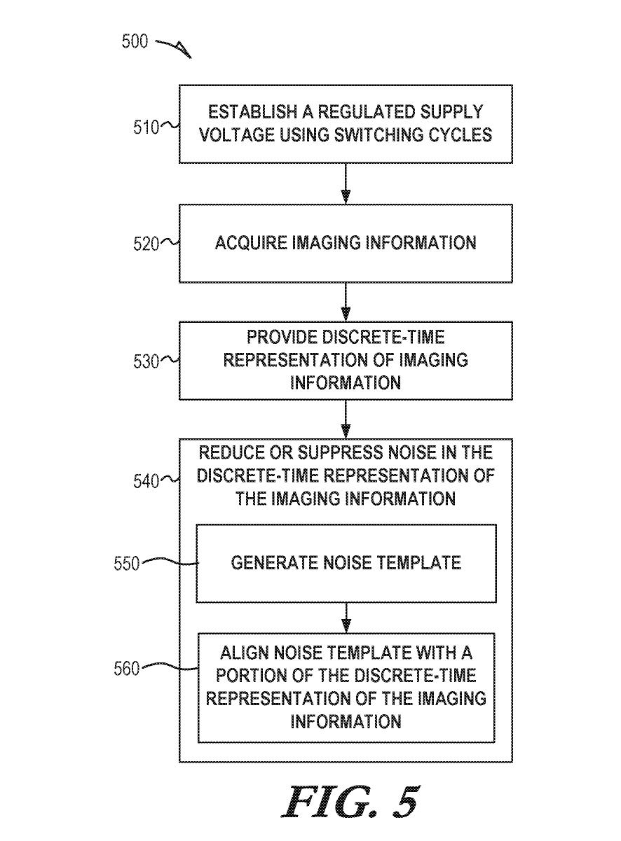

FIG. 5 illustrates generally a technique 500, such as a method, that can include reducing or suppressing noise in an acquired discrete-time representation of imaging information, such as at least in part using a noise template as shown and described in relation to other examples herein. At 510, a regulated supply voltage can be established using switching cycles defined at least in part according to a switching clock period (e.g., a “PMU clock” period). At 520, imaging information can be acquired from an imaging sensor. For example, imaging information can be acquired from a charge-coupled device (CCD) imaging sensor via sequentially shifting columns of charge corresponding to stored intensities into a row shift register, and then transferring each row of charges out of the CCD imaging sensor for sampling.

Similarly, a Complementary Metal-Oxide-Semiconductor (CMOS) imaging sensor can be used, and at 520, imaging information can be acquired by sequentially addressing and reading out stored charge values at each pixel location in the imaging sensor. At 530, a discrete-time representation of the imaging information can be provided, such as after readout and sampling by an image acquisition circuit comprising and analog front end (AFE). Generally, if switching events are occurring in relation to operation of a switched-mode power supply, such switching events cause noise to be coupled to the AFE during readout, and such noise appears in acquired imaging information and in the discrete-time representation provided at 530.

At 540, noise in the discrete-time representation of the imaging information can be reduced or suppressed. Such noise can be caused by operation of a switched mode power supply. In an example, at 550, a noise template can be generated. The noise template can be a discrete-time (e.g., digital) representation, such as stored in a memory. A count of values in the noise template can be less than a count of an entirety of a physical row of pixels from the imaging sensor. The noise template can be generated by aggregating partitioned portions of imaging information acquired from physical rows of pixels from the imaging sensor, such as from an optically-black region. At 560, the noise template can be aligned with a discrete-time representation of the acquired imaging information, such as shown and described in other examples herein. A signal contribution (e.g., an intensity contribution) from the noise template can then be subtracted from the discrete-time representation of the imaging information, such as to at least partially cancel the noise in the discrete-time representation corresponding to operation of the switched-mode power supply.

FIG. 6 illustrates generally a timing diagram showing a relationship between various discrete-time signals, such as can be used in relation to a Time-of-Flight (TOF) imaging technique. As mentioned above, noise coupling can occur during acquisition of imaging information from an imaging sensor. Noise coupling can also occur during actual image capture by the imaging sensor. In applications such as TOF imaging, such noise coupling can introduce unwanted error in ranging or phase information, compromising an accuracy of measurements derived from TOF imaging. In an example, a pixel clock signal 610 having a period 680 can be provided (e.g., derived from or representative of a master clock provided at a clock input “CLI”). An illumination signal 620 (such as for a laser diode “LD” or other illumination source) can be provided, such as derived from the pixel clock 610. The illumination signal 620 can have a period 670. A shutter signal (such as a substrate bias signal “SUB”) 630 can be provided, such as defining an exposure duration “EXPOSURE.”

Operation of a switched-mode power supply can be controlled, such as using one or more switching cycles synchronized or masked with respect to one or more of the illumination signal 620 or the shutter signal 630. For example, a switching cycle duration 660 can be established as a sub-multiple of the pixel clock period 680. Switching cycles can be suppressed entirely during one or more of the illumination signal logic “high” or shutter signal logic “low” durations (such logic states are illustrative; other states can be used to define exposure and illumination).

In another example, such as where the switching signal 640 represents a control signal for a pulse-width-modulated (PWM) control mode, a duration of a switching pulse may need to be extended to a duration 650, such as spanning one or more illumination and exposure cycles. In such an example, one or more of a rising edge 690A or a falling edge 690B can be suppressed during exposure or illumination. According to these examples, noise in the analog representation of the image stored in the imaging sensor caused by switching events can be reduced or suppressed during capture. Such techniques can be combined with the noise reduction or suppression techniques described elsewhere herein in relation to image acquisition after capture.

FIG. 7 illustrates generally a technique 700, such as a method, that can include reducing or suppressing noise during image capture in relation to Time-of-Flight (TOF) imaging. At 710, a regulated supply voltage can be established using switching cycles defined at least in part according to a switching clock period (e.g., a “PMU clock” period). At 720, an illumination output signal can be provided, such as to trigger an illumination source (e.g., by a laser diode) synchronously with capture of an image by an imaging sensor. At 730, one or more switching events (such as defining a portion or an entirety of switching cycle) can be suppressed, such as during one or more of illumination or capture of an image by the imaging sensor. At 740, a discrete-time representation of the imaging information can be acquired, such as using other noise suppression or reduction techniques as described elsewhere herein.

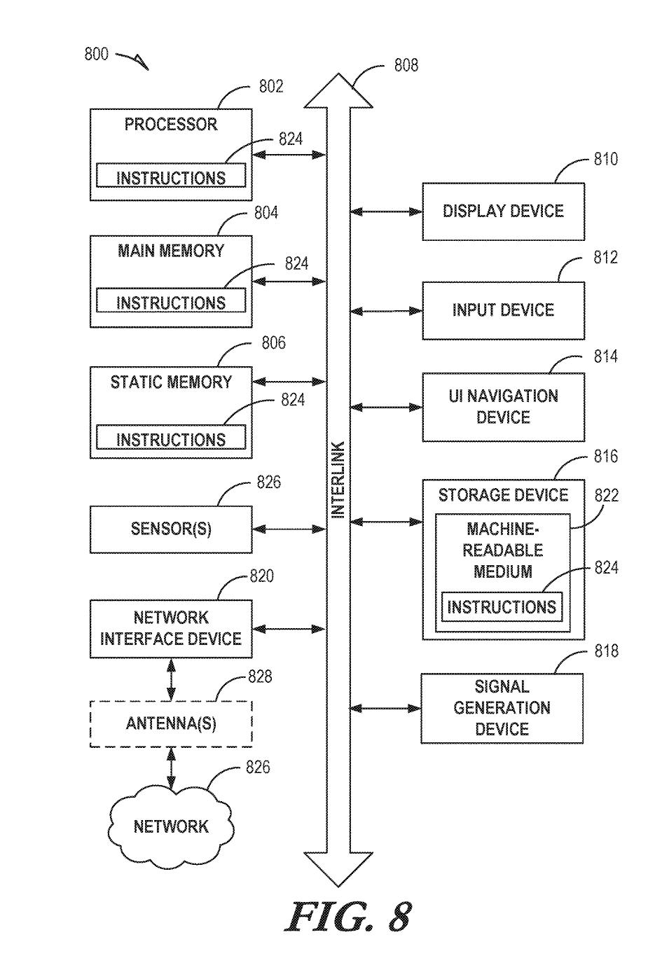

FIG. 8 illustrates generally a block diagram of a machine 800 upon which any one or more of the techniques (e.g., methodologies) discussed herein can be performed. In alternative embodiments, the machine 800 can operate as a standalone device or can be connected (e.g., networked) to other machines. In a networked deployment, the machine 800 can operate in the capacity of a server machine, a client machine, or both in server-client network environments. In an example, the machine 800 can act as a peer machine in peer-to-peer (P2P) (or other distributed) network environment. The machine 800 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate by, logic or a number of components, or mechanisms. Circuit sets are a collection of circuits implemented in tangible entities that include hardware (e.g., transistor-based circuits or other circuits, gates, logic, etc.). Circuit set membership can be flexible over time and underlying hardware variability. Circuit sets include members that can, alone or in combination, perform specified operations when operating. In an example, hardware of the circuit set can be immutably designed to carry out a specific operation (e.g., hardwired). In an example, the hardware of the circuit set can include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components can be used in more than one member of more than one circuit set. For example, under operation, execution units can be used in a first circuit of a first circuit set at one point in time and reused by a second circuit in the first circuit set, or by a third circuit in a second circuit set at a different time.

Machine (e.g., computer system) 800 can include a hardware processor 802 (e.g., a central processing unit (CPU), a graphics processing unit (GPU), a hardware processor core, or any combination thereof), a main memory 804 and a static memory 806, some or all of which can communicate with each other via an interlink (e.g., bus) 808. The machine 800 can further include a display unit 810 (e.g., a raster display, vector display, holographic display, etc.), an alphanumeric input device 812 (e.g., a keyboard), and a user interface (UI) navigation device 814 (e.g., a mouse). In an example, the display unit 810, input device 812 and UI navigation device 814 can be a touch screen display. The machine 800 can additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 can include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 can include a machine readable medium 822 on which is stored one or more sets of data structures or instructions 824 (e.g., software) embodying or utilized by any one or more of the techniques or functions described herein. The instructions 824 can also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 can constitute machine readable media. While the machine readable medium 822 is illustrated as a single medium, the term “machine readable medium” can include a single medium or multiple media (e.g., a centralized or distributed database, and/or associated caches and servers) configured to store the one or more instructions 824.

The term “machine readable medium” can include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples can include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 can further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as WiFi®, IEEE 802.16 family of standards known as WiMax®), IEEE 802.15.4 family of standards, peer-to-peer (P2P) networks, among others. In an example, the network interface device 820 can include one or more physical jacks (e.g., Ethernet, coaxial, or phone jacks) or one or more antennas to connect to the communications network 826. In an example, the network interface device 820 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### Various Notes & Examples

Example 1 can include or use subject matter (such as an apparatus, a method, a means for performing acts, or a device readable medium including instructions that, when performed by the device, can cause the device to perform acts), such as can include or use an electronic system, comprising a switched-mode power supply circuit configured to establish a regulated supply voltage, the switched-mode power supply circuit configured to operate using switching cycles defined at least in part according to a switching clock period, an imaging acquisition circuit comprising an input configured to acquire imaging information from an imaging sensor and an output configured to provide a discrete-time representation of the imaging information acquired from the imaging sensor, and a discrete-time noise suppression circuit coupled to the output of the imaging acquisition circuit, the discrete-time noise suppression circuit configured to receive the discrete-time representation of the imaging information and configured to reduce or suppress in the discrete-time representation noise corresponding to operation of the switched-mode power supply circuit during acquisition of the imaging information. The discrete-time noise suppression circuit can include a discrete-valued noise template stored in a memory, wherein a count of values in the noise template is less than a count of an entirety of a physical row of pixels from the imaging sensor, and a noise subtraction circuit configured to align the discrete-valued noise template with a portion of the discrete-time representation of the imaging information and configured to use the aligned template to at least partially cancel the noise in the discrete-time representation corresponding to operation of the switched-mode power supply circuit.

Example 2 can include, or can optionally be combined with the subject matter of Example 1, to optionally include that the count of values in the noise template corresponds to a duration comprising an integral number of switching clock periods.

Example 3 can include, or can optionally be combined with the subject matter of one or any combination of Examples 1 or 2 to optionally include that the count of values in the noise template corresponds to a duration comprising a single switching clock period.

Example 4 can include, or can optionally be combined with the subject matter of one or any combination of Examples 1 through 3 to optionally include a noise template generation circuit configured to establish the discrete-valued noise template by aggregating acquired imaging information from an optically-black portion of the imaging sensor.

Example 5 can include, or can optionally be combined with the subject matter of Example 4, to optionally include that the noise template generation circuit is configured to establish the discrete-valued noise template by acquiring imaging information and partitioning the imaging information into segments each corresponding to a length of the noise template.

Example 6 can include, or can optionally be combined with the subject matter of Example 5, to optionally include that the noise template generation circuit is configured to receive a representation of a switching clock signal defining the switching clock period and configured to generate segment boundary locations corresponding to successive periods of the switching clock signal.

Example 7 can include, or can optionally be combined with the subject matter of Example 6, to optionally include that the noise template generation circuit is configured to reconstruct a signal representative of the switching clock signal by sampling the switching clock signal.

Example 8 can include, or can optionally be combined with the subject matter of Example 6, to optionally include that the noise template generation circuit is configured to establish the discrete-valued noise template by determining a central tendency of a value for each location within the segments, the template comprising values of the determined central tendencies at each location.

Example 9 can include, or can optionally be combined with the subject matter of Example 6, to optionally include that the noise template generation circuit is configured to establish the discrete-valued noise template by averaging an intensity value for each location within the segments, the template comprising values of the determined averages at each location.

Example 10 can include, or can optionally be combined with the subject matter of one or any combination of Examples 1 through 9 to optionally include that the imaging acquisition circuit is configured to acquire imaging information from the imaging sensor according to a specified pixel acquisition rate and that the power supply switching clock period corresponds to a switching rate that is less than the pixel acquisition rate.

Example 11 can include, or can optionally be combined with the subject matter of claim 10 to optionally include that the power supply switching clock is established asynchronously with respect to a clock used for establishing the pixel acquisition rate.

Example 12 can include, or can optionally be combined with the subject matter of one or any combination of Examples 10 or 11 to optionally include that the switching rate is a sub-multiple of the pixel acquisition rate.

Example 13 can include, or can optionally be combined with the subject matter of one or any combination of Examples 1 through 12 to optionally include an illumination output, the illumination output configured to provide an illumination output signal coupleable to an illumination source, wherein the illumination output signal is generated to trigger illumination of a target synchronously with capture of an image by the imaging sensor.

Example 14 can include, or can optionally be combined with the subject matter of claim 13 to optionally include that the switched-mode power supply circuit is configured to inhibit or suppress switching events during one or more of illumination or capture of an image by the imaging sensor.

Example 15 can include, or can optionally be combined with the subject matter of claim 14 to optionally include that the imaging sensor and the illumination source, wherein the imaging sensor, the illumination source, the switched-mode power supply circuit, and the discrete-time noise suppression circuit comprise a time-of-flight (TOF) imaging system.

Example 16 can include, or can optionally be combined with the subject matter of one or any combination of Examples 1 through 15 to optionally include further comprise the imaging sensor.

Example 17 can include, or can optionally be combined with the subject matter of claim 16 to optionally include that the imaging sensor is co-integrated with at least a portion of one or more of the image acquisition circuit, the noise suppression circuit, or the switched-mode power supply.

Example 18 can include, or can optionally be combined with the subject matter of one or any combination of Examples 1 through 17 to include, subject matter (such as an apparatus, a method, a means for performing acts, or a machine readable medium including instructions that, when performed by the machine, that can cause the machine to perform acts), such as can include an system, comprising a switched-mode power supply circuit configured to establish a regulated supply voltage, the switched-mode power supply circuit configured to operate using switching cycles defined at least in part according to a switching clock period, an imaging acquisition circuit comprising an input configured to acquire imaging information from the imaging sensor and an output configured to provide a discrete-time representation of the imaging information acquired from the imaging sensor, and a discrete-time noise suppression circuit coupled to the output of the imaging acquisition circuit, the discrete-time noise suppression circuit configured to receive the discrete-time representation of the imaging information and configured to reduce or suppress in the discrete-time representation noise corresponding to operation of the switched-mode power supply circuit during image capture. The switched-mode power supply circuit configured to inhibit or suppress switching events during one or more of illumination or capture of an image by the imaging sensor according to a signal from the discrete-time noise suppression circuit, and the electronic system comprising the imaging sensor and the illumination source configured to provide a time-of-flight (TOF) imaging system.

Example 19 can include, or can optionally be combined with the subject matter of one or any combination of Examples 1 through 18 to include, subject matter (such as an apparatus, a method, a means for performing acts, or a machine readable medium including instructions that, when performed by the machine, that can cause the machine to perform acts), such as can include establishing a regulated supply voltage using switching cycles defined at least in part according to a switching clock period, acquiring imaging information from an imaging sensor, providing a discrete-time representation of the imaging information acquired from the imaging sensor, and receiving the discrete-time representation of the imaging information and reducing or suppressing in the discrete-time representation noise during the acquisition of the imaging information, including generating a discrete-valued noise template stored in a memory, wherein a count of values in the noise template is less than a count of an entirety of a physical row of pixels from the imaging sensor and aligning the discrete-valued noise template with a portion of the discrete-time representation of the imaging information and at least partially canceling the noise in the discrete-time representation using the aligned discrete-valued noise template.

Example 20 can include, or can optionally be combined with the subject matter of claim 19 to optionally include establishing the discrete-valued noise template by aggregating acquired imaging information from an optically-black portion of the imaging sensor.

Example 21 can include, or can optionally be combined with the subject matter of claim 20 to optionally include establishing the discrete-valued noise template by acquiring imaging information and partitioning the imaging information into segments each corresponding to a length of the noise template.

Example 22 can include, or can optionally be combined with the subject matter of one or any combination of Examples 20 through 22 to optionally include establishing the discrete-valued noise template by determining a central tendency of a value for each location within the segments, the template comprising values of the determined central tendencies at each location.

Example 23 can include, or can optionally be combined with the subject matter of one or any combination of Examples 19 through 22 to optionally include acquiring the imaging information from the imaging sensor according to a specified pixel acquisition rate, and that the switching clock period corresponds to a switching rate that is less than the pixel acquisition rate.

Example 24 can include, or can optionally be combined with the subject matter of claim 23 to optionally include that the switching rate is a sub-multiple of the pixel acquisition rate.

Example 25 can include, or can optionally be combined with the subject matter of one or any combination of Examples 23 or 24 to optionally include that the power supply switching clock is established asynchronously with respect to a clock used for establishing the pixel acquisition rate.

Example 26 can include, or can optionally be combined with the subject matter of one or any combination of Examples 19 through 25 to optionally include providing an illumination output signal to trigger illumination of an imaging target synchronously with capture of an image by the imaging sensor.

Example 27 can include, or can optionally be combined with the subject matter of one or any combination of Examples 19 through 26 to optionally include inhibiting or suppressing power supply switching events during one or more of illumination or capture of an image by the imaging sensor.

Example 28 can include, or can optionally be combined with the subject matter of claim 23 to optionally include inhibiting or suppressing power supply switching events during illumination and capture of an image by the imaging during time-of-flight (TOF) imaging.

Each of these non-limiting examples can stand on its own, or can be combined in various permutations or combinations with one or more of the other examples. While the examples described herein generally refer to two-dimensional imaging sensors, the techniques described are also applicable to line-based imaging sensors. For example, a noise template can include a record length comprising a portion (rather than an entirety) of a line-based imaging sensor.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An electronic system, comprising:
an imaging acquisition circuit comprising:
an input configured to acquire imaging information from an imaging sensor; and
an output configured to provide a discrete-time representation of the imaging information acquired from the imaging sensor;
a discrete-time noise suppression circuit coupled to the output of the imaging acquisition circuit, the discrete-time noise suppression circuit configured to receive the discrete-time representation of the imaging information and configured to reduce or suppress in the discrete-time representation noise corresponding to operation of a switched-mode power supply circuit during acquisition of the imaging information, the discrete-time noise suppression circuit including:
a discrete-valued noise template stored in a memory, wherein a count of values in the noise template is less than a count of an entirety of a physical row of pixels from the imaging sensor; and
a noise subtraction circuit configured to align the discrete-valued noise template with a portion of the discrete-time representation of the imaging information and configured to use the aligned template to at least partially cancel the noise in the discrete-time representation corresponding to operation of the switched-mode power supply circuit;
wherein the count of values in the noise template corresponds to a duration comprising an integral number of switching clock periods of the switched-mode power supply.

2. (canceled)

3. The electronic system of claim 1, wherein the count of values in the noise template corresponds to a duration comprising a single switching clock period.

4. (canceled)

5. The electronic system of claim 1, wherein the noise template generation circuit is configured to establish the discrete-valued noise template by acquiring imaging information and partitioning the imaging information into segments each corresponding to a length of the noise template.

6. The electronic system of claim 5, wherein the noise template generation circuit is configured to receive a representation of a switching clock signal defining a switching clock period and configured to generate segment boundary locations corresponding to successive periods of the switching clock signal.

7. (canceled)

8. The electronic system of claim 6, wherein the noise template generation circuit is configured to establish the discrete-valued noise template by determining a central tendency of a value for each location within the segments, the template comprising values of the determined central tendencies at each location.

9. The electronic system of claim 6, wherein the noise template generation circuit is configured to establish the discrete-valued noise template by averaging an intensity value for each location within the segments, the template comprising values of the determined averages at each location.

10. The electronic system of claim 1, wherein the imaging acquisition circuit is configured to acquire imaging information from the imaging sensor according to a specified pixel acquisition rate; and
wherein the power supply switching clock period corresponds to a switching rate that is less than the pixel acquisition rate.

11-14. (canceled)

15. The electronic system of claim 1, further comprising the imaging sensor, the switched-mode power supply circuit, and an illumination source, wherein the imaging sensor, the illumination source, the switched-mode power supply circuit, and the discrete-time noise suppression circuit comprise a time-of-flight (TOF) imaging system.

16-17. (canceled)

18. An electronic system, comprising:
a switched-mode power supply circuit configured to establish a regulated supply voltage, the switched-mode power supply circuit configured to operate using switching cycles defined at least in part according to a switching clock period;
an imaging acquisition circuit comprising:
an input configured to acquire imaging information from the imaging sensor; and
an output configured to provide a discrete-time representation of the imaging information acquired from the imaging sensor;
a discrete-time noise suppression circuit coupled to the output of the imaging acquisition circuit, the discrete-time noise suppression circuit configured to receive the discrete-time representation of the imaging information and configured to reduce or suppress in the discrete-time representation noise corresponding to operation of the switched-mode power supply circuit during image capture;
wherein the switched-mode power supply circuit is configured to inhibit or suppress switching events during one or more of illumination or capture of an image by the imaging sensor according to a signal from the discrete-time noise suppression circuit; and
wherein the electronic system comprises the imaging sensor and an illumination source configured to provide a time-of-flight (TOF) imaging system.

19-28. (canceled)

29. The electronic system of claim 18, wherein the count of values in the noise template corresponds to a duration comprising an integral number of switching clock periods of the switched-mode power supply.

30. The electronic system of claim 29, wherein the count of values in the noise template corresponds to a duration comprising a single switching clock period.

31. The electronic system of claim 18, wherein the noise template generation circuit is configured to establish the discrete-valued noise template by acquiring imaging information and partitioning the imaging information into segments each corresponding to a length of the noise template.

32. The electronic system of claim 31, wherein the noise template generation circuit is configured to receive a representation of a switching clock signal defining a switching clock period and configured to generate segment boundary locations corresponding to successive periods of the switching clock signal.

33. The electronic system of claim 31, wherein the noise template generation circuit is configured to establish the discrete-valued noise template by determining a central tendency of a value for each location within the segments, the template comprising values of the determined central tendencies at each location.

34. The electronic system of claim 18, wherein the power supply switching clock is established asynchronously with respect to a clock used for establishing a pixel acquisition rate for acquisition of imaging information from the imaging sensor.

35. The electronic system of claim 34, wherein the switching rate is a sub-multiple of the pixel acquisition rate.

36. An electronic system, comprising:
an imaging acquisition circuit comprising:
an input configured to acquire imaging information from an imaging sensor according to a specified pixel acquisition rate; and
an output configured to provide a discrete-time representation of the imaging information acquired from the imaging sensor,
a discrete-time noise suppression circuit coupled to the output of the imaging acquisition circuit, the discrete-time noise suppression circuit configured to receive the discrete-time representation of the imaging information and configured to reduce or suppress in the discrete-time representation noise corresponding to operation of a switched-mode power supply circuit during acquisition of the imaging information, the discrete-time noise suppression circuit including:
a discrete-valued noise template stored in a memory, wherein a count of values in the noise template is less than a count of an entirety of a physical row of pixels from the imaging sensor; and
a noise subtraction circuit configured to align the discrete-valued noise template with a portion of the discrete-time representation of the imaging information and configured to use the aligned template to at least partially cancel the noise in the discrete-time representation corresponding to operation of the switched-mode power supply circuit;
wherein a switching clock associated with the switching power supply circuit is established asynchronously with respect to a clock used for establishing the pixel acquisition rate.

37. The electronic system of claim 36, comprising an illumination output, the illumination output configured to provide an illumination output signal coupleable to an illumination source, wherein the illumination output signal is generated to trigger illumination of a target synchronously with capture of an image by the imaging sensor.

38. The electronic system of claim 37, further comprising the switched mode power supply circuit; and
wherein the switched-mode power supply circuit is configured to inhibit or suppress switching events during one or more of illumination or capture of an image by the imaging sensor.

39. The electronic system of claim 36, further comprising the imaging sensor, the switched-mode power supply circuit, and an illumination source, wherein the imaging sensor, the illumination source, the switched-mode power supply circuit, and the discrete-time noise suppression circuit comprise a time-of-flight (TOF) imaging system.
